(19) United States
(12) Patent Application Publication
(10) Pub. No.: US 2024/0421508 A1
(43) Pub. Date: Dec. 19, 2024

(54) Mechanical connector for connecting an electrical cable

(71) Applicant: TYCO ELECTRONICS - SIMEL, Gevrey-Chambertin (FR)

(72) Inventor: Bruno Peltier, Gevrey-Chambertin (FR)

(21) Appl. No.: 18/743,488

(22) Filed: Jun. 14, 2024

(30) Foreign Application Priority Data
Jun. 19, 2023 (EP) 23305973.2

(51) Int. Cl. H01R 4/30; H01R 4/36

(52) U.S. Cl. CPC H01R 4/307; H01R 4/36

(57) ABSTRACT

The present invention relates to mechanical connector (10, 100) for connecting an electrical cable (1) comprising a longitudinal internal bore (14) configured for receiving the electrical cable (1) and a transverse threaded hole (22, 24, 26, 28, 102) extending into the longitudinal internal bore (14). The mechanical connector (10, 100) comprises a laterally-open groove (34) recessed in an internal wall (20) along a longitudinal direction (Y) of the longitudinal internal bore (14). The groove (34) has a higher curvature value (R2) than a curvature value (R1) of the longitudinal internal bore (34), and is substantially arranged opposite to the transverse threaded hole (22, 24, 26, 28, 102). The present invention further relates to methods for manufacturing such mechanical connector (10, 100) and a method for assembling the mechanical connector (10, 100) with an electrical cable (1).

### RELATED APPLICATION(S)

The present application claims priority to and the benefit of European Patent Application No. 23305973.2, filed Jun. 19, 2023, the disclosure of which is hereby incorporate herein by reference in its entirety.

### FIELD OF INVENTION

The present invention relates to a mechanical connector for connecting an electrical cable. The present invention further relates to methods for manufacturing such mechanical connector and a method for assembling the mechanical connector with an electrical cable.

### BACKGROUND OF THE INVENTION

Electrical cables, like electric power cables, of all sizes may be connected together using connectors made from electrically conductive material. There are different types of connectors for joining electrical cables. For instance, it is known that mechanical connectors use at least one bolt, shear bolt, or screw, to tighten an electrical cable, without the need for crimping.

It is desirable that the mechanical connector provides a stable electrical connection. Moreover, it is desirable that the mechanical connector provides a sufficient resistance to a pulling force exerted to the longitudinal direction of the electrical cable for preventing an unwanted separation between the electrical cable and the mechanical connector. A common way to determine the mechanical performance of the mechanical connector is to perform a pull-out or pull-off test. Pull-out or pull-off tests are tensile tests. They can be performed according to certain standards, like the international standard IEC 61238-1-2, edition 1.0 of May 2018 (“IEC” for International Electrotechnical Commission).

An object of the present invention is to provide a mechanical connector with improved electrical and mechanical performances. In particular, there is a need for providing a mechanical connector allowing increasing the pullout performance of an electrical cable tightening therein.

More in particular, an object of the present invention is to improve the electrical and mechanical performances of a mechanical connector also designed for electrical high-voltage cables.

Voltage levels above 1 kV (kilovolt) in the case of alternating current, and over 1.5 kV in the case of direct current are commonly considered high-voltage. Nowadays, the term “high voltage” covers the former medium voltage (abbreviated “MV” or “HVA” and comprised between 1 kV and 50 kV) and the former high voltage (abbreviated “HV” or “HVB” and greater than 50 kV). Electrical high-voltage cable can be used for electrical power transmission, including for submarine applications. For instance, electrical high-voltage cables may be used in the field of offshore wind systems. An electrical cable, in particular a high-voltage electrical cable, comprises one or more conductors and at least one insulating material layer surroundings the conductors. A stripped end portion of the electrical cable is inserted inside the mechanical connector and tightened by means of at least one bolt, shear bolt, or screw.

The conductor core of an electrical cable, in particular for voltage levels above 1 kV and up to 50 kV, may have a diameter comprised between 1 millimeter and 80 millimeters, in particular between 10 millimeters and 50 millimeters.

As the tensile strength of a cable is proportional to its transversal cross-section, it is desirable that a mechanical connector for such electrical cables provides a greater resistance to pullout than a mechanical connector for cables of a smaller size.

An object of the invention is thus to improve the pullout performance, in particular of an electrical cable for voltage level above 1 kV and/or for an electrical cable having a conductor core's diameter comprised between 1 millimeters and 80 millimeters, more in particular between 10 and 50 millimeters.

### DESCRIPTION OF THE INVENTION

The object of the present invention is achieved by means of a mechanical connector for connecting an electrical cable according to claim 1. The mechanical connector comprises an electrically conductive connector body. The electrically conductive connector body has a longitudinal internal bore configured for receiving an electrical cable. The longitudinal internal bore is defined by an internal wall of the electrically conductive connector body. The electrically conductive connector body has a transverse threaded hole extending through the connector body into the longitudinal internal bore. The electrically conductive connector body further comprises a laterally-open groove recessed in the internal wall. The groove extends along a longitudinal direction of the electrically conductive connector body. In a cross-section of the electrically conductive connector body transversal to the longitudinal internal bore, the groove has a higher curvature value than a curvature value of the longitudinal internal bore, and the groove is substantially arranged opposite to the transverse threaded hole. The curvature value may be defined by determining the radius of curvature.

In this configuration, the laterally-open groove (of higher curvature value than the curvature of the longitudinal internal bore) defines two lateral edges in the internal wall of the longitudinal internal bore. Said lateral edges, like the laterally-open groove, extend along the longitudinal direction of the electrically conductive connector body. The lateral edges of the groove provide two contact lines along the longitudinal direction of the electrically conductive connector body for the electrical cable.

In fact, as in a transversal cross-section of the connector body, the groove is substantially arranged opposite to the transverse threaded hole, the transverse threaded hole is arranged with respect to the groove such that the force generated by a coupling bolt, when screwed in the transverse threaded hole, is configured to exert a compression force (or compressive force) pushing the electrical cable towards at least one of the lateral edges of the groove, in particular towards both the lateral edges of the groove. The compression of the cable on the lateral edges of the groove, rather than on another region of the internal wall of the electrically conductive connector body, allows increasing the contact force (or reaction force). Indeed, in a transversal cross-section of the mechanical connector, a first normal contact force is generated at a first contact point defined by the contact of the cable with one of the lateral edges of the groove. A second normal contact force is generated at a second contact point defined by the contact of the cable with the other lateral edge of the groove. The cable is thus tighten between the first contact point and the second point, which respectively exert a normal reaction on the cable. The arrangement of the groove with respect to the transverse threaded hole and its specific curvature thus advantageously enable providing contact points for the cable on the curvature on the internal wall.

In comparison to a mechanical connector of the state of the art not comprising such groove, the contact forces are improved as the result of the so-called “wedge-effect” which allows creating greater normal forces at the lateral edges of the groove (i.e. at the contact points) with a similar tightening force. The pull-out or pull-off performance of the mechanical connector can thus be improved because the tightening of the cable is enhanced. Hence, the mechanical connector enhances the fixity of the electrical cable. In particular, as the result of the pushing force applied to the cable by tightening the coupling bolt, the cable may be bent and pressed towards the lateral edges of the groove. It allows improving the electrical contact between the mechanical connector and the electrical cable. Moreover, the lateral edges of the groove may allow centralize and/or stabilize the electrical cable within the longitudinal internal bore. Overall, both the mechanical and the electrical stability can be improved by means of the mechanical connector according to the present invention.

In the present invention, the feature “substantially arranged opposite” in relation to the arrangement of the groove with respect to the transverse threaded hole, means that in a cross-section of the electrically conductive connector body transversal to the longitudinal internal bore, the transverse threaded hole can extend along an axis offset from the line joining the center of the longitudinal internal bore and the center of the groove by an angle of 35 degrees at most, in particular of 25 degrees.

The line joining the center of the longitudinal internal bore and the center of the groove may be considered as a reference line. The offset angle between the reference line and the axis of the transverse threaded hole can be expressed as a positive angle or a negative angle, depending on the orientation of the axis of the transverse threaded hole with respect to the reference line. According to the present invention, within this angle range [−35°; +35° ], the groove is substantially arranged opposite to the transverse threaded hole. The “wedge-effect” can be achieved within this angle range comprised between −35° and +35°.

In a preferred embodiment, the offset angle range is comprised between −25° and +25°.

The mechanical connector can be further improved according to various embodiments.

According to one embodiment, in a cross-section of the electrically conductive connector body transversal to the longitudinal internal bore, an axis of the transverse threaded hole may be aligned with the line joining the center of the longitudinal internal bore and the center of the groove. In this configuration, the tightening of the coupling bolt in the transverse threaded hole generates symmetrical contact forces on the cable. In a transversal cross-section view, the axis of the transverse threaded hole is actually centered with the lateral edges of the groove as said axis passes through the center of the curved groove.

According to one embodiment, the mechanical connector may comprise two or more transverse threaded holes. An increasing amount of transverse threaded holes allows receiving further coupling bolts, which enhances the pullout performance of the cable connected in the mechanical connector.

The plurality of transverse threaded holes may be arranged such that the respective axis of the two or more transverse threaded holes are not parallel to one another. The resulting offset arrangement of the transverse threaded holes provides further space between two adjacent transverse threaded holes than if there were aligned one behind the others. Hence, larger screw head or bolt head may be used in this configuration.

Alternatively, the plurality of transverse threaded holes may be arranged such that the respective axis of the two or more transverse threaded holes are parallel to one another, and, in particular aligned with the line joining the center of the longitudinal internal bore and the center of the groove. Such configuration may improve the compactness of the mechanical connector. The tightening of the several coupling bolts in the respective transverse threaded hole will generate symmetrical contact forces on the cable.

According to one embodiment, the groove may be a semi-circular groove. The longitudinal internal bore may have a circular transversal cross-section. A radius of the longitudinal internal bore may be strictly greater than a radius of the groove. In particular, said radius of the longitudinal internal bore corresponds to the internal radius of the longitudinal internal bore. In this geometric configuration, a greater curvature is thus achieved for the groove because the radius of the groove is strictly smaller than the radius of the longitudinal internal bore. In fact, the curvature is defined as the inverse of the radius of curvature. Curvature can be determined through the use of the second derivative. A semi-circular groove can be manufactured relatively easily and cost-efficiently, by either extrusion or milling for instance.

The diameter of each transverse threaded bore may be strictly smaller than the diameter of the longitudinal internal bore. It may improve the mechanical strength of the body of the mechanical connector.

In a transversal cross-section view of the mechanical connector, the distance between the contact points (i.e. the distance between the lateral edges of the groove) may be determined by the radius of the groove with respect to the radius of the longitudinal internal bore. Optionally, the length of the segment joining the center of the longitudinal internal bore and the center of the groove may also allow adjusting the distance between the contact points.

According to one embodiment, the radius of the groove may be at least 50% of the radius of the longitudinal internal bore. In particular, the radius of the groove may be comprised between 60 and 80% of the radius of the longitudinal internal bore. Within this range dimension, an improvement of the results to experimental pullout tests have been obtained.

According to one embodiment, the internal radius of the longitudinal internal bore may be comprised between 1 to 50 millimeters. This range of radius is adapted for receiving an electrical cable for voltage level above 1 kV, and in particular up to 50 kV. An electrical cable for voltage level above 1 kV, and in particular up to 50 kV, may comprise a core conductor with a radius comprised between 0.5 millimeter and 40 millimeters, in particular between 5 millimeters and 25 millimeters.

According to one embodiment, the groove may be formed by at least two sub-grooves respectively extending along the longitudinal direction of the electrically conductive connector body. In this configuration, the groove may be formed by the removal of less material than in a configuration of a single groove. For instance, in a groove comprising a plurality of sub-grooves and having the same width than a groove made of one single recess, the sectional lateral wall between two adjacent sub-grooves may not be removed. It may thus improve the mechanical strength of the body of the mechanical connector.

According to one embodiment, the internal wall of the longitudinal internal bore and/or the groove may be serrated. The resulting serrations may provide further contact points with the cable. It allows improving the friction, and may also enhance the pull-out resistance.

According to one embodiment, the mechanical connector may further comprise a coupling bolt adapted to be fastened in the transverse threaded hole and to tighten an electrical cable received in the longitudinal internal bore. The force generated by the coupling bolt screwed in the transverse threaded hole is configured to push the electrical cable towards at least one lateral edge of the groove, thereby increasing the contact force for a better pullout resistance, and enhancing the surface contact for a better electrical stability.

According to one embodiment, the electrically conductive connector body may have a cylindrical outer shape, in particular a cylindrical shape with a circular transversal cross-section. The cylindrical shape prevents the presence of protruding portions. The absence of protruding portions is preferable for high voltage applications. Moreover, an insulating layer can be more easily applied over a cylindrical shape than over a shape with protruding or angular portions. Because the provision of an insulating layer is particularly relevant for high voltage applications, the cylindrical mechanical connector is thus well adapted for receiving electrical high voltage cables.

According to one embodiment, the electrically conductive connector body may be integrally formed in one-piece. It allows reducing the number of loose parts, and the number of assembly steps. Hence, this configuration reduces the operating procedure of assembly and improves work efficiency. In contrast to the state of the art, the presence of an additional shim in the longitudinal internal bore, for instance, is not required.

The object of the present invention is further achieved by means methods for manufacturing the above-described mechanical connector. According to a first method, the longitudinal internal bore and the groove of the electrically conductive connector body are simultaneously formed by extrusion of a metal material. The first method allows forming the longitudinal internal bore and the groove in one common step. The mechanical connector can thus be easily manufactured at relatively low costs.

According to a second method, the method for manufacturing the mechanical connector may comprise: a first step of forming the longitudinal internal bore, in particular by extrusion; and a second step, after the first step, of forming the groove by milling the internal wall of the electrically conductive connector body. The second method allows re-using existing electrical cable connector having a longitudinal internal bore but not the groove according to the presence invention, merely by achieving the milling step. The mechanical connector can thus be easily manufactured at relatively low costs.

The object of the present invention is also achieved by means of a method for assembling an electrical cable to the above-described mechanical connector. The assembly method comprises the steps of: inserting the electrical cable into the longitudinal internal bore and a coupling bolt in the transverse threaded hole, fastening the coupling bolt in the transverse threaded hole so as to tighten the electrical cable, in particular so as to tighten the electrical cable against an edge of the groove. As the force generated by the coupling bolt screwed in the transverse threaded hole is configured to push the electrical cable towards at least one lateral edge of the groove, it allows increasing the contact force for a better pullout resistance, and enables enhancing the surface contact for a better electrical stability.

According to one embodiment, the assembly method can further comprise a step of mounting an insulation sleeve around the mechanical connector. The provision of an insulation sleeve is particularly adapted for high-voltage applications. The insulation sleeve may be formed of a dielectric or electrically insulative material. According to one embodiment, the insulation sleeve may be formed of an elastically expandable material. According one embodiment, the insulation sleeve may formed of an elastomeric material.

As used herein, the singular forms “a”, “an” and “the” are intended to include the plural forms as well, unless the context clearly indicates otherwise.

### DESCRIPTION OF THE FIGURES

The accompanying figures are incorporated into the specification and form a part of the specification to illustrate several embodiments of the present invention. These figures, together with the description serve to explain the principles of the invention. The figures are merely for the purpose of illustrating the preferred and alternative examples of how the invention can be made and used, and are not to be construed as limiting the invention to only the illustrated and described embodiments. Furthermore, several aspects of the embodiments may form—individually or in different combinations—solutions according to the present invention. The following described embodiments thus can be considered either alone or in a combination thereof. Further features and advantages will become apparent from the following more particular description of the various embodiments of the invention, as illustrated in the accompanying figures, in which like references refer to like elements, and wherein:

FIG. 1 schematically illustrates a mechanical connector according to a first embodiment and an example of an electrical cable;

FIG. 2 schematically illustrates a transversal cross-section view of the mechanical connector according to the first embodiment without electrical cables;

FIG. 3 schematically illustrates the transversal cross-section view of the mechanical connector according to the first embodiment with an electrical cable;

FIG. 4 schematically illustrates a transversal cross-section view of a mechanical connector according to a second embodiment with an electrical cable.

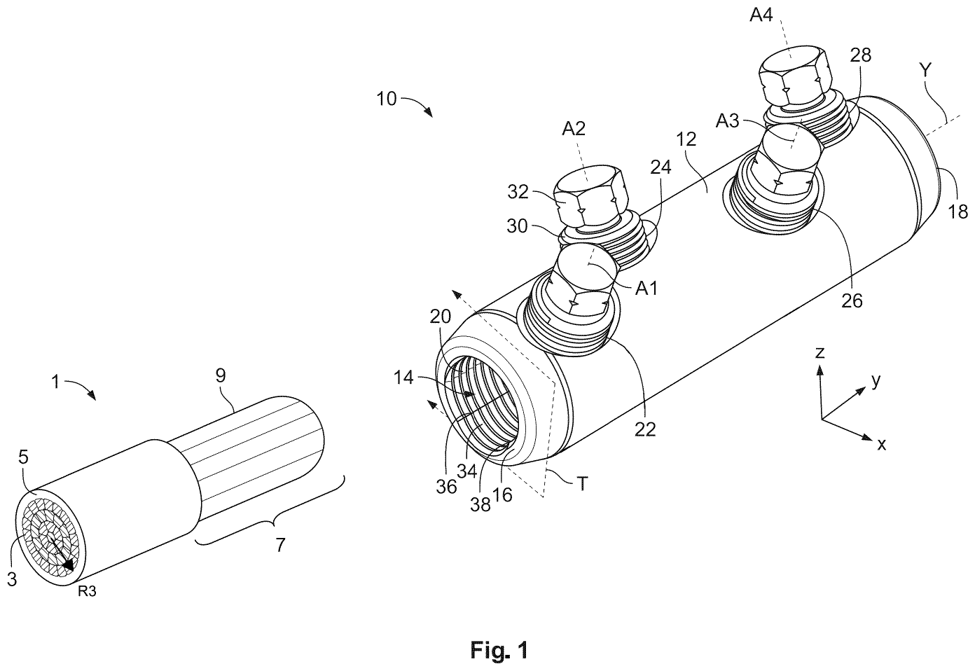

FIG. 1 schematically illustrates a mechanical connector 10 according to a first embodiment. The mechanical connector 10 comprises an electrically conductive connector body 12. In the first embodiment, the body 12 is made of metal and is integrally formed in one-piece. The body 12 in the first embodiment is thus a unitary piece formed or composed of a material without joints. In the first embodiment, the electrically conductive connector body 12, ‘body 12’ thereafter, has a cylindrical outer shape extending along an axis ‘Y’ shown in FIG. 1. In a variant, the body 12 may have a different outer shape, like a prism shape.

The body 12 comprises a longitudinal internal bore 14 extending along the axis Y. The longitudinal internal bore 14 extends from a first end 16 of the body 12 to a second opposite end 18 of the body 12 along the axis Y. The longitudinal internal bore 14 is defined by an internal wall 20 of the body 12. In the example of FIG. 1, the internal wall 20 has a serrated surface. As a result, the inner wall 20 is not a smooth surface because the internal wall 20 comprises a plurality of corrugations. As shown in FIG. 1, the corrugations are formed by a succession of ridges and recesses along the axis Y. A serrated surface may improve the grip. In an alternative, the internal wall 20, or at least or portion of the internal wall 20, may have a smooth surface. The longitudinal internal bore 14 may be formed by an extrusion process. The longitudinal internal bore 14 is configured for receiving electrical cables respectively at the first end 16 and the second end 18. An example electrical cable 1 is represented in FIG. 1.

An electrical cable may comprise one or more solid conductors. Alternatively or in combination, the electrical cable may comprise one or more stranded conductors. A transversal cross-section of the electrical cable may have a circular, an oval or a shape intermediate between a circular and an oval shape. In particular, the electrical cable may be a round cable. A transversal cross-section of around cable is circular. The electrical cable may be a sector cable. The sector cable may comprise a plurality of conductors, each conductor forming a section of a circle in a transversal cross-section of the electrical cable. According to one embodiment, the electrical cable is a high-voltage power transmission cable.

In the non-limiting example of the FIG. 1, the electrical cable 1 is a round cable and comprises a plurality of strand conductors 3, forming the core of the electrical cable 1, surrounded by an electrically insulating layer 5. The section 7 of the electrical cable 1 adapted to be inserted and locked in the mechanical connector 10 is a stripped portion 9 from which the electrically insulating layer 5 has been removed so as to directly exposed the strand conductors 3. The core of the electrical cable 1 has a radius R3. The radius R3 may be comprised between 0.5 millimeter and 40 millimeters, in particular between 5 millimeters and 25 millimeters.

In the first embodiment, the longitudinal internal bore 14 comprises four transverse threaded holes 22, 24, 26, 28. The number of transverse threaded holes is not limitative. The transverse threaded holes 22, 24, 26, 28 respectively extend through the body 12 into the longitudinal internal bore 14. The four transverse threaded holes 22, 24, 26, 28 respectively constitute lateral openings in the body 12. The four transverse threaded holes 22, 24, 26, 28 respectively have a circular shape threaded for receiving a coupling bolt 30.

The coupling bolts 30 serve as securing mechanisms to anchor, affix or secure the electrical cable 1 to the connector body 12, and to thereby ensure mechanical and electrical connection between the strand conductors 3 and the connector body 12. In some embodiments, the clamping bolts 30 are shear bolts. The coupling bolts 30 may each be constructed and used in the same manner. Therefore, the description of one coupling bolt 30 applies likewise to the other coupling bolts 30.

In the example of FIG. 1, the four transverse threaded holes 22, 24, 26, 28 are represented in an offset configuration. In the offset configuration, the transverse threaded holes 22, 24, 26, 28 are not all aligned with one another. The offset configuration allows providing sufficient space for using coupling bolts 30 having larger head bolts 32 than in an aligned configuration. The aligned configuration may, however, be advantageously more compact than the offset configuration.

The two transverse threaded holes 22, 24 may be configured for respectively receiving a coupling bolt 30 for tightening a first electrical cable (e.g. the electrical cable 1) inserted in the longitudinal internal bore 14 through the first end 16. The two transverse threaded holes 26, 28 may be configured for respectively receiving a coupling bolt 30 for tightening a second electrical cable (not represented) inserted in the longitudinal internal bore 14 through the second end 18, so as to that the mechanical connector 10 connects the first and the second electrical cables.

As shown in FIG. 1, the body 12 further comprises a laterally-open groove 34 recessed in the internal wall 20. The groove 34 extends along the longitudinal direction of the electrically conductive connector body 12, i.e. along the axis Y represented in FIG. 1. The groove 34 is substantially arranged opposite to the transverse threaded holes 22, 24, 26, 28. In the example of FIG. 1, the groove 34 has a serrated surface, like the surface of the inner wall 20. In a variant embodiment, the groove 34 may have a smooth surface. The groove 34 and the inner wall 20 may have different surface finishes. As shown in FIG. 1, the groove 34 defines two lateral edges 36, 38 on the inner wall 20, that respectively extend along the axis Y.

The curvature of the groove 34 is greater than the curvature of the longitudinal internal bore 14. The curvature value of the groove 34 may be defined by the radius of curvature of the groove 34 in a transversal cross-section T of the body 12 in the plane (XZ). In the example of FIG. 1, the groove 34 is a semi-circular groove. Hence, in this example, the radius of curvature of the groove 34 corresponds to the radius R2 of the semi-circular groove. In the first embodiment, the semi-circular groove 34 has a substantially uniform radius R2 along the axis Y from the first end 16 to the second end 18 of the body 12. In an alternative, the groove 34 is not a semi-circular groove but a curved groove with a radius curvature greater than the curvature of the longitudinal internal bore 14.

The curvature value of the longitudinal internal bore 14 may be defined by the radius of curvature of the longitudinal internal bore 14 in the transversal cross-section T of the body 12, at a curved position of the inner wall 20 different from the position of the groove 34. In the example of FIG. 1, the longitudinal internal bore 14 has a circular shape. Hence, in this example, the radius of curvature of the longitudinal internal bore 14 corresponds to the internal radius R1 of said circular shape. In the first embodiment, the longitudinal internal bore 14 has a substantially uniform internal radius R1 along the axis Y from the first end 16 to second end 18 of the body 12.

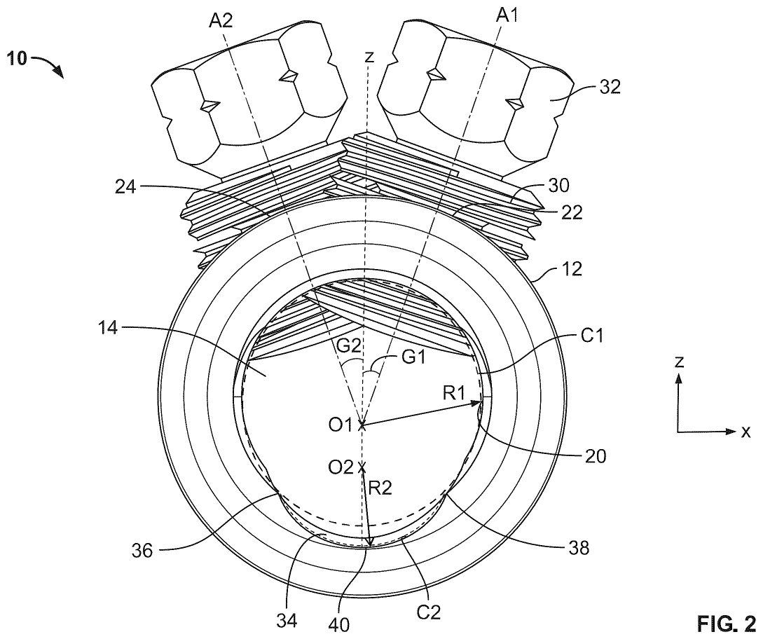

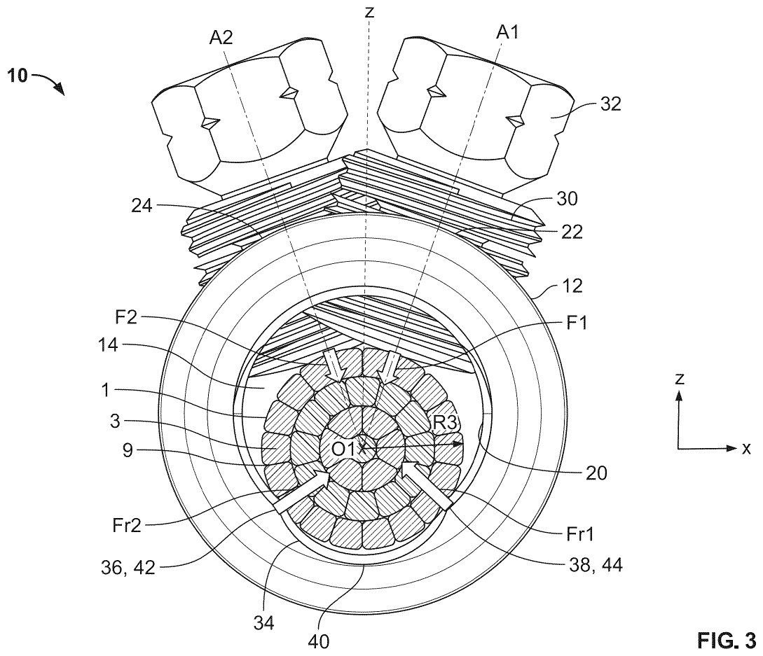

Schematic views according to the transversal cross-section T of the body 12 are illustrated by the FIGS. 2 and 3, which are used in the following to further describe the arrangement of the groove 34 within the mechanical connector 10.

FIG. 2 schematically illustrates a transversal cross-section view of the mechanical connector 10 of FIG. 1 in the plane (XZ). As mentioned above, in the first embodiment, the longitudinal internal bore 14 has a circular shape. As shown in FIG. 2, the longitudinal internal bore 14 has a hollow circular opening C1 of radius R1. Moreover, in the first embodiment, the groove 34 is a semi-circular groove defined by a curvature C2 of radius R2. The internal radius R1 of the longitudinal internal bore 14 is strictly greater than the radius R2 of the groove 34. The radius R2 of the groove 34 is at least 50% of the internal radius R1 of the longitudinal internal bore 14. In particular, the radius R2 of the groove 34 is comprised between 60 and 80% of the internal radius R1 of the longitudinal internal bore 14. Within this range dimension, an improvement of the results to experimental pullout tests have been obtained.

The lateral edges 36, 38 are located at the intersection of the hollow circular opening C1 and the curvature C2 in the plane (XZ) may advantageously provide contact points to an electrical cable, as explained thereafter in reference to FIG. 3.

In the configuration of the first embodiment, as shown in FIGS. 1 and 2, the transverse threaded holes 22, 24, 26, 28 are not all aligned with one another. According to the present application, the groove 34 is substantially arranged opposite to all transverse threaded holes 22, 24, 26, 28 as long as each transverse threaded hole extends along an axis A offset from the line joining the center O1 of the longitudinal internal bore 14 and the center O2 of the groove 34 by an angle of 35 degrees at most. In FIG. 2, the line joining the center O1 of the longitudinal internal bore 14 and the center O2 of the groove 34 extends along the axis Z. In the first embodiment illustrated by FIG. 2, the longitudinal axis A1 of the transverse threaded hole 22 (respectively 26) defines a positive angle G1 of about 20 degrees with respect to the axis Z. The longitudinal axis A2 of the transverse threaded hole 24 (respectively 28) defines a negative angle G2 of about 20 degrees with respect to the axis Z.

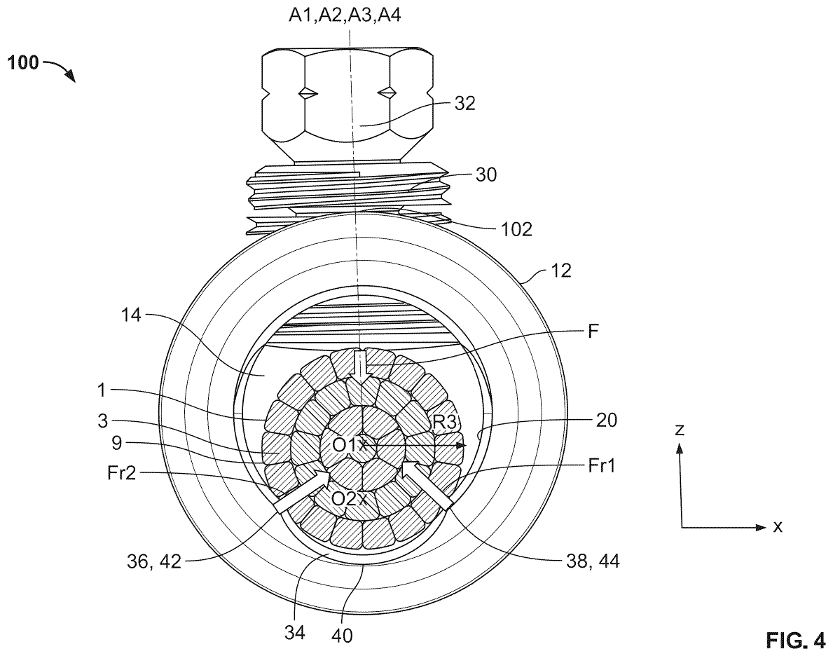

In an aligned configuration of the mechanical connector, like illustrated by FIG. 4, the respective longitudinal axis A of all transverse threaded holes 22, 24, 26, 28 are aligned with the line joining the center O1 of the longitudinal internal bore 14 and the center O2 of the groove 34 along the axis Z. As a result, in the aligned configuration, the angles G1 and G2 are zero.

Preferably, the internal radius R1 of the longitudinal internal bore 14 may be strictly greater than the internal radius of the transverse threaded holes 22, 24, 26, 28. The transverse threaded holes 22, 24, 26, 28 may have the same internal radius. It allows using identical coupling bolts 30 for all transverse threaded holes 22, 24, 26, 28 of the mechanical connector 10.

FIG. 3, like FIG. 2, schematically illustrates a transversal cross-section view of the mechanical connector 10 in the plane (XZ). In comparison to FIG. 2, FIG. 3 shows the electrical cable 1 inserted in the mechanical connector 10. More precisely, the stripped portion 9 of the electrical cable 1 is inserted in the longitudinal internal bore 14. The stripped portion 9 (i.e. the core of the electrical cable) has a substantially circular cross section of radius R3. The radius R2 (shown in FIG. 2) of the groove 34 is smaller than the radius R3. The stripped portion 9 would otherwise be fitted in the groove 34. However, to obtain the effects of increasing the contact reaction forces and the contact surface, it is best when the electrical cable 1, in particular the stripped portion 9, does not touch the bottom 40 of the groove 34, but rather lies on the lateral edges 36, 38 of the groove 34, as shown in FIG. 3.

The tightening (e.g. the screwing) of the coupling bolts 30 causes their displacement along the respective longitudinal axis A1, A2 of the transverse threaded holes 22, 24 towards the center O1 of the longitudinal internal bore 14. When the electrical cable 1 is inserted in the longitudinal internal bore 14, the coupling bolts 30 respectively exert a force on the electrical cable 1 directed towards the center O1 of the longitudinal internal bore 14, as shown by the arrows F1, F2 on FIG. 3. The forces F1, F2, in particular their resulting force along the axis Z, push the electrical cable 1 towards the bottom 40 of the groove 34. The presence of the groove 34 in the mechanical connector 10 causes the abutment of the electrical cable 1 against the lateral edges 36, 38. The lateral edges 36, 38 create contact lines for the electrical cable 1. In the transversal cross-section of FIG. 3, the surface contact between the lateral edges 36, 38 and the electrical cable 1 is represented by the contact points 42, 44.

The compression of the cable 1 on the lateral edges 38, 38 of the groove 34, rather than on another region of the internal wall 20 of the body 12, allows increasing the two contact forces (or reaction force) Fr1, Fr2 respectively applied at the contact points 42, 44. As shown in FIG. 3, a first normal contact force Fr1 is in fact generated at the first contact point 44. A second normal contact force Fr2 is generated at the second contact point 42. The cable 1 is thus tighten between the first contact point 42 and the second contact point 44, which respectively exert normal reaction forces Fr1, Fr2 on the cable 1. The respective direction of the normal reaction forces Fr1, Fr2 is inclined with respect to the direction of the resulting pushing force (i.e. the sum of the projection of the forces F1 and F2 along the axis Z). Hence, the lateral edges 36, 38 of the groove 34 exert a wedging effect on the electrical cable 1. The wedging effect promotes greater contact reaction forces Fr1, Fr2 at same pushing forces F1, F2 (same direction and same magnitude) and same radius R3 than in a configuration of a mechanical connector devoid of a groove 34. During assembly, the tightening step thus remains the same for an operator, but advantageously results in a better fixation of the electrical cable 1 with the mechanical connector 10. Another benefit of the mechanical connector 10, in comparison to a mechanical connector devoid groove 34, is the provision of larger contact surfaces with the electrical cable 1 at the contact points 42, 44. More strands conductor 2 can directly be in contact with the body 12. This results in a better electrical behavior and also better pull out test results.

FIG. 4 schematically illustrates a transversal cross-section view of a mechanical connector 100 according to a second embodiment. Elements with the same reference numeral already described and illustrated in the preceding figures will not be described in detail again but reference is made to their description above.

The difference between the mechanical connector 100 according to the second embodiment and the mechanical connector 10 according to the first embodiment, is that the second embodiment relates to an aligned configuration of the transverse threaded holes, while the first embodiment reflects an offset configuration.

Accordingly, in the second embodiment, all the transverse threaded holes 102 are aligned with one another, such that their respective axis A1, A2, A3, A4 are parallel to one another. In the example of FIG. 4, the axis A1, A2, A3, A4 are all aligned with the axis Z and pass through the line joining the center O1 of the longitudinal internal bore 14 and the center O2 of the groove 34. Hence, in contrast to the offset configuration shown in FIG. 2, the angles G1 and G2 are zero in the second embodiment (and are thus not visible in FIG. 4).

As can be taken from FIG. 4, in this configuration, the respective axis A1, A2, A3, A4 of the transverse threaded holes 102 are centered with the groove 34. The force F exerted by each coupling bolt 30 is thus applied along a direction substantially perpendicular to the bottom 40 of the groove 34. The groove 34 is positioned diametrically opposite the pushing force F.

Like in the first embodiment, a wedging effect is advantageously achieved by means of the design of the second embodiment thanks to the configuration of the groove 34. Reference is thus made to the description above regarding the wedging effect.

Hereafter, an assembly method of the mechanical connector 10 with the electrical cable 1 is described in reference to FIG. 1, FIG. 2 and FIG. 3.

In reference to FIG. 1, the assembly method comprises a step of stripping the insulating layer 5 over a portion 9 of the electrical cable 1 so as to expose directly the strand conductors 3. The assembly method further comprises a step of insertion the stripped portion 9 of the electrical cable 1 in the longitudinal internal bore 14 of the body 12 through the first end 16. The same preceding steps are carried out for a second electrical cable to be inserted through the second end 18. The assembly method comprises a step of respectively inserting coupling bolts 30 in the transverse threaded holes 22, 24, 26, 28. The coupling bolts 30 can then be fastened in the respective transverse threaded holes 22, 24, 26, 28. As a result, the coupling bolts 30 push the electrical cable 1 against the lateral edges 36, 38 of the groove 34, as shown in FIG. 3.

Optionally, the assembly method may further comprise a step of mounting an electrically isolative sleeve, like an elastomeric sleeve, around the body 12 mechanical connector 10 (not represented).

The above described assembly method also applies for the mechanical connector 100 according to the second embodiment.

The mechanical connectors 10, 100 according to both embodiments may be manufactured by extrusion. Extrusion is a manufacturing process that allows forming profiles of constant transversal cross-section. The profiles are obtained by means of a die opening, through which metal or other materials is pushed therethrought. The mechanical connectors 10, 100 may be directly extruded with a groove 34 thanks to a corresponding pre-shape die. Alternatively, the groove 34 may be formed after the body 12 of the mechanical connectors 10, 100 is produced, by machining tools for material removal (e.g. milling). In either cases, the mechanical connectors 10, 100 can be easily manufactured at low costs.

All previously discussed embodiments are not intended as limitations but serve as examples illustrating features and advantages of the invention. It is to be understood that some or all of the above described features can also be combined in different ways.

### REFERENCE SIGNS

1: electrical cable
3: strand conductors
5: electrically insulating layer
7: section of the electrical cable
9: stripped portion
10: mechanical connector according to the first embodiment
12: electrically conductive connector body
14: longitudinal internal bore
16: first end
18: second end
20: inner wall
22, 24, 26, 28: transverse threaded holes
30: coupling bolt
32: bolt head
34: groove
36, 38: lateral edges of the groove
40: bottom of the groove
42, 44: contact points
100: mechanical connector according to the second embodiment
102: transverse threaded hole
X, Y, Z: Cartesian coordinate system
A1, A2, A3, A4: axis of transverse threaded holes
C1, C2: curvatures
F, F1, F2: forces
Fr1, Fr2: reaction forces
O1, O2: center of curvature/circle
R1, R2, R3: radius
T: transversal cross-section of the body (12) in the plane (XZ)

What is claimed is:

1. A mechanical connector (10, 100) for connecting an electrical cable (1), comprising an electrically conductive connector body (12), the electrically conductive connector body (12) having:
a longitudinal internal bore (14) configured for receiving an electrical cable (1),
the longitudinal internal bore (14) being defined by an internal wall (20) of the electrically conductive connector body (12), and
a transverse threaded hole (22, 24, 26, 28, 102) extending through the connector body (12) into the longitudinal internal bore (14),
the electrically conductive connector body (12) further comprising a laterally-open groove (34) recessed in the internal wall (20), the groove (34) extending along a longitudinal direction (Y) of the electrically conductive connector body (12), and
in a cross-section of the electrically conductive connector body (12) transversal to the longitudinal internal bore (14):
the groove (34) has a higher curvature value (R2) than a curvature value (R1) of the longitudinal internal bore (34), and
the groove (34) is substantially arranged opposite to the transverse threaded hole (22, 24, 26, 28, 102).

2. The mechanical connector (10, 100) according to claim 1, wherein, in a cross-section of the electrically conductive connector body (12) transversal to the longitudinal internal bore (14), the transverse threaded hole (22, 24, 26, 28, 102) extends along an axis (A1, A2, A3, A4) offset from the line joining the center (O1) of the longitudinal internal bore (14) and the center (O2) of the groove (34) by an angle (G1, G2) of 35 degrees at most.

3. The mechanical connector (100) according to claim 1, wherein, in a cross-section of the electrically conductive connector body (12) transversal to the longitudinal internal bore (14), an axis (A1, A2, A3, A4) of the transverse threaded hole (102) is aligned with the line joining the center (O1) of the longitudinal internal bore (14) and the center (O2) of the groove (34).

4. The mechanical connector (10, 100) according to claim 1, comprising two or more transverse threaded holes (22, 24, 26, 28, 102), in particular arranged such that the respective axis (A1, A2, A3, A4) of the two or more transverse threaded holes (22, 24, 26, 28) are not parallel to one another.

5. The mechanical connector (10, 100) according to claim 4, wherein the groove (34) is a semi-circular groove, and the longitudinal internal bore (14) has a circular transversal cross-section (C1), and a radius (R1) of the longitudinal internal bore (14) is strictly greater than a radius (R2) of the groove (34).

6. The mechanical connector (10, 100) according to claim 5, wherein the radius (R2) of the groove (34) is at least 50% of the radius (R1) of the longitudinal internal bore (14), in particular the radius (R2) of the groove (34) is comprised between 60% and 80% of the radius (R1) of the longitudinal internal bore (14).

7. The mechanical connector (10, 100) according to claim 1, wherein the internal radius (R1) of the longitudinal internal bore (14) is comprised between 1 to 50 millimeters.

8. The mechanical connector (10, 100) according to claim 1, wherein the groove (34) is formed by at least two sub-grooves respectively extending along the longitudinal direction (Y) of the electrically conductive connector body (12),

9. The mechanical connector (10, 100) according to claim 1, wherein the internal wall (20) of the longitudinal internal bore (14) and/or the groove (34) is serrated.

10. The mechanical connector (10, 100) according to claim 1, further comprising a coupling bolt (30) adapted to be fastened in the transverse threaded hole (22, 24, 26, 28, 102) and to tighten an electrical cable (1) received in the longitudinal internal bore (14).

11. The mechanical connector (10, 100) according to claim 1, wherein the electrically conductive connector body (12) has a cylindrical outer shape, in particular a cylindrical shape with a circular transversal cross-section.

12. The mechanical connector (10, 100) according to claim 1, wherein the electrically conductive connector body (12) is integrally formed in one-piece.

13. Method for manufacturing a mechanical connector (10, 100) according to claim 1, wherein the longitudinal internal bore (14) and the groove (34) of the electrically conductive connector body (12) are simultaneously formed by extrusion of a metal material.

14. Method for manufacturing a mechanical connector (10, 100) according to claim 1, comprising:
a first step of forming the longitudinal internal bore (14), in particular by extrusion; and
a second step, after the first step, of forming the groove (34) by milling the internal wall (20) of the electrically conductive connector body (12).

15. Method for assembling an electrical cable (1) to the mechanical connector (10, 100) according to claim 1, comprising the steps of:
inserting the electrical cable (1) into the longitudinal internal bore (14) and inserting a coupling bolt (30) in the transverse threaded hole (22, 24, 26, 28, 102), and
fastening the coupling bolt (30) in the transverse threaded hole (22, 24, 26, 28, 102) so as to tighten the electrical cable (1), in particular so as to tighten the electrical cable (1) against an edge (36, 38) of the groove (34).
